(19) United States
(12) Patent Application Publication
(10) Pub. No.: US 2026/0264579 A1
(43) Pub. Date: Sep. 10, 2026

(54) RECLINING DEVICE

(71) Applicant: DELTA KOGYO CO., LTD., Hiroshima (JP)

(72) Inventor: Hiroki OSHIMO, Hiroshima (JP)

(73) Assignee: DELTA KOGYO CO., LTD., Hiroshima (JP)

(21) Appl. No.: 19/153,781

(22) PCT Filed: Jan. 30, 2024
(86) PCT No.: PCT/JP2024/002897

§ 371 Date: Aug. 5, 2025

(30) Foreign Application Priority Data
Mar. 16, 2023 (JP) 2023-041676

(51) Int. Cl. B60N 2/235; B60N 2/70

(52) U.S. Cl. CPC B60N 2/236; B60N 2/70

(57) ABSTRACT

A reclining device includes a guide bracket, an internal gear, a plurality of lock gears, and a rotation cam. At least one of the lock gears has at least one gear bulge. The gear bulge has at least one portion forming an arc to protrude toward a cam face of the rotation cam. The arc has a center located at: an intersection of a first imaginary line extending in a direction in which a resultant force including a radially inward force from the internal gear in a locking state and a second imaginary line extending in a direction in which a load to enter the lock gear from the rotation cam through the gear bulge and acts; or a position between the intersection and the gear bulge on the second imaginary line.

### TECHNICAL FIELD

The present invention relates to a reclining device for a seat.

### BACKGROUND ART

A reclining device has been conventionally and widely adopted for a vehicle seat or the like. For instance, Patent Literature 1 discloses such a reclining device for a seat. The reclining device for a seat disclosed in Patent Literature 1 will be described with reference to FIG. 11.

As illustrated in FIG. 11, Patent Literature 1 discloses a reclining device 9 for a seat (hereinafter, referred to as “conventional reclining device 9”), including a guide bracket 91, an internal gear 92, a plurality of lock gears 93, a rotation cam 94, and a lock spring (not shown). The internal gear 92 has a cylindrical part in an annular shape and a bottom wall configured to close an opening at an end of the cylindrical part (opening at a depth in FIG. 11). The internal gear 92 has internal teeth 92e on an inner circumferential surface of the cylindrical part.

Each of the lock gears 93 is arranged inward from the cylindrical part of the internal gear 92 movably in a radial direction of the internal gear 92. Each lock gear 93 has an external tooth 93a configured to mesh with the associated internal tooth 92e of the internal gear 92 when moving toward a radially outside of the internal gear 92. The lock gear 93 is radially movable by sliding along a side wall (guide wall) of a guide part 91c provided at the guide bracket 91.

The rotation cam 94 is rotatable about a radial center of the internal gear 92. The rotation cam 94 has a cam face 94c on an outer circumference thereof to come into contact with a section (contact section 93g) of a radially inward surface (inner circumferential surface) 93f of each of the lock gears 93. Referring to an enlarged view in FIG. 11, the cam face 94c of the rotation cam 94 engages with the contact section 93g of the inner circumferential surface 93f of the lock gear 93 and pushes the lock gear 93 radially outward to place the reclining device 9 in a locking state where the internal tooth 92e of the internal gear 92 and the external tooth 93a of each lock gear 93 mesh. In contrast, releasing the engagement of the cam face 94c of the rotation cam 94 with the contact section 93g of the inner circumferential surface 93f of the lock gear 93 places the device in an unlocking state where the external tooth 93a of each lock gear 93 leaves the internal tooth 92e of the internal gear 92 radially inward.

As described heretofore, the reclining device 9 switches between the locking state and the unlocking state in response to a rotation operation of the rotation cam 94 to enable adjustment of an angle of the seatback to the seat cushion.

In the reclining device, one of the guide bracket 91 and the internal gear 92 is configured to be fixedly attached to the seatback, and the other is configured to be fixedly attached to the seat cushion so that the reclining device is placed in the locking state where the external tooth 93a meshes with the internal tooth 92e at running of the vehicle. In this condition, if the reclining device receives a high load from the seatback due to, for example, a vehicle collision, the external tooth 93a of the lock gear 93 may come off from the internal tooth 92e and the lock gear 93 may rotate. This may result in failing to maintain the locking state and damaging the external tooth 93a in the reclining device. Such tendency is remarkably seen in variation in dimensional accuracy of the lock gear 93.

As illustrated in the enlarged view in FIG. 11, such variation in the dimensional accuracy of the lock gear 93 may cause circumferentially directional deviation of an engagement portion of the contact section 93g of the inner circumferential surface 93f of the lock gear 93 and the cam face 94c of the rotation cam 94 from a designed and intended position. If the engagement portion between the contact section 93g of the inner circumferential surface 93f of the lock gear 93 and the cam face 94c of the rotation cam 94 deviates in the circumferential direction from the designed and intended position, as shown in FIG. 12, an intersection between a resultant force F91 including a force acting radially inward from the internal gear 92 with the internal tooth 92e and the external tooth 93a meshing and a load F92 acting from the rotation cam 94 to the lock gear 93 deviate in the circumferential direction from a point P91 serving as the designed and intended position to a point P92, P93 (arrow C1).

If a moment input F9 is given to the internal gear 92 in a state where the intersection (intersection P92, P93) between the resultant force F91 and the load F92 deviates from the designed and intended position (intersection P91), a reaction force F93 from the guide part 91c to the lock gear 93 at a radially outer position of the intersection P92, P93 differs from a reaction force F94 at a radially inner position thereof. Such a difference between the reaction forces F93, F94 may generate a rotational force F95 to the lock gear 93. As a result, the external teeth 93a of the lock gear 93 mesh with the internal teeth 92e of the internal gear 92 only in a portion C2, and a gap comes into existence in another portion C3. Accordingly, the lock gear 93 may be damaged in the portion C2.

Described heretofore is an example configuration including the guide bracket 91 configured to be fixedly attached to the seat cushion, and the internal gear 92 configured to be fixedly attached to the seatback. Another configuration including the guide bracket 91 configured to be fixedly attached to the seatback and the internal gear 92 configured to be fixedly attached to the seat cushion is also considered to have the same disadvantages described above.

### CITATION LIST

### Patent Literature Patent Literature 1: Japanese Unexamined Patent Publication No. 2015-147010

### SUMMARY OF INVENTION

The present invention has been accomplished in view of the disadvantages, and has an object of providing a reclining device for a seat that achieves prevention of a reduction in locking strength even against a high load from a seatback with tolerance to variation in dimensional accuracy of a lock gear.

A reclining device for a seat according to an aspect of the present invention includes a guide bracket, an internal gear, a plurality of lock gears, and a rotation cam. The guide bracket is configured to be fixedly attached to one of a seat cushion and a seatback. The internal gear is configured to be fixedly attached to the other of the seat cushion and the seatback in such a manner as to be rotatable relative to the guide bracket, the internal gear having internal teeth on an inner circumferential surface thereof. The lock gears are each located on a radially inside of the internal gear movably in a radial direction of the internal gear, and each have an external tooth configured to mesh with an associated internal tooth among the internal teeth. The rotation cam is located on the radially inside relative to the lock gears rotatably about a radial center of the internal gear. The rotation cam further has a cam face to come into contact with at least a surface section of an inner circumferential surface being a radially inward surface of each of the lock gears, and is configured to switch between a locking state and an unlocking state. The locking state is a state where the internal tooth and the external tooth mesh depending on a pushing state from the cam face to the face section. The unlocking state is a state where the meshing of the internal tooth and the external tooth is released.

The guide bracket has a guide wall that guides corresponding one of the lock gears to move in the radial direction. The at least one of the lock gears has at least one gear bulge in a region of the surface section of the inner circumferential surface that faces the cam face of the rotation cam. At least a portion of the at least one gear bulge forms an arc to protrude toward the cam face.

The gear bulge is in such a form that the arc of the gear bulge has a center located at: an intersection of a first imaginary line and a second imaginary line; or a position between the intersection and the gear bulge on the second imaginary line. The first imaginary line extends in a direction in which a resultant force including a radially inward force from the internal gear in the locking state acts. The second imaginary line extends in a direction in which a load to enter the lock gear from the rotation cam through the gear bulge acts.

### BRIEF DESCRIPTION OF DRAWINGS

FIG. 1 is an exploded perspective view illustrating a configuration of a reclining device for a seat according to an embodiment.

FIG. 2A is a perspective view illustrating a configuration of an internal gear.

FIG. 2B is a perspective view illustrating a configuration of a rotation cam.

FIG. 3A is a perspective view illustrating a configuration of a lock gear.

FIG. 3B is a perspective view illustrating a configuration of a guide bracket.

FIG. 4 is an illustration of the reclining device in a locking state.

FIG. 5 is an illustration of the reclining device in an unlocking state.

FIG. 6 is an illustration of a detailed structure of the lock gear.

FIG. 7 is an illustration of a detailed structure of the rotation cam.

FIG. 8 is an illustration of application of a resultant force including a radially inward force from the internal gear, and application of a load from the rotation cam to the lock gear.

FIG. 9 is an illustration of application of a force from the guide wall to the lock gear, and application of a reaction force with respect to the force.

FIG. 10 is an illustration (with a partially enlarged view) of a configuration of a reclining device for a seat according to a modification.

FIG. 11 is an illustration (with a partially enlarged view) of a reclining device for a seat according to a prior art.

FIG. 12 is an illustration for explanation of a directional deviation of load application from a rotation cam to a lock gear depending on a moment input in the reclining device for a seat according to the prior art.

### DESCRIPTION OF EMBODIMENTS

Hereinafter, an embodiment of the present invention will be described with reference to the accompanying drawings. It is noted that the following embodiment illustrates one example of the present invention, and the present invention is not limited to the embodiment except its essential configuration.

### Embodiment

### 1. Configuration of a Reclining Device 1 for a Seat

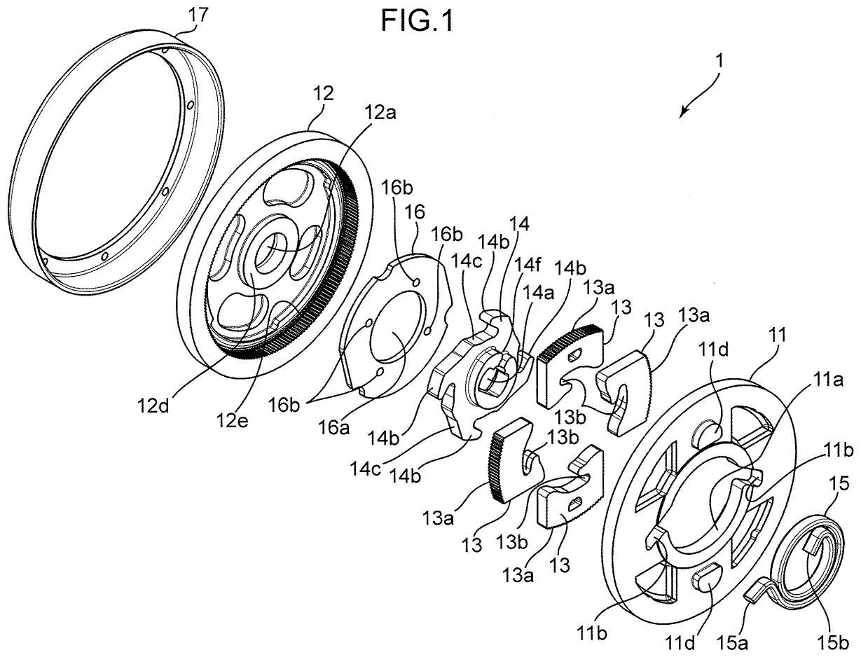

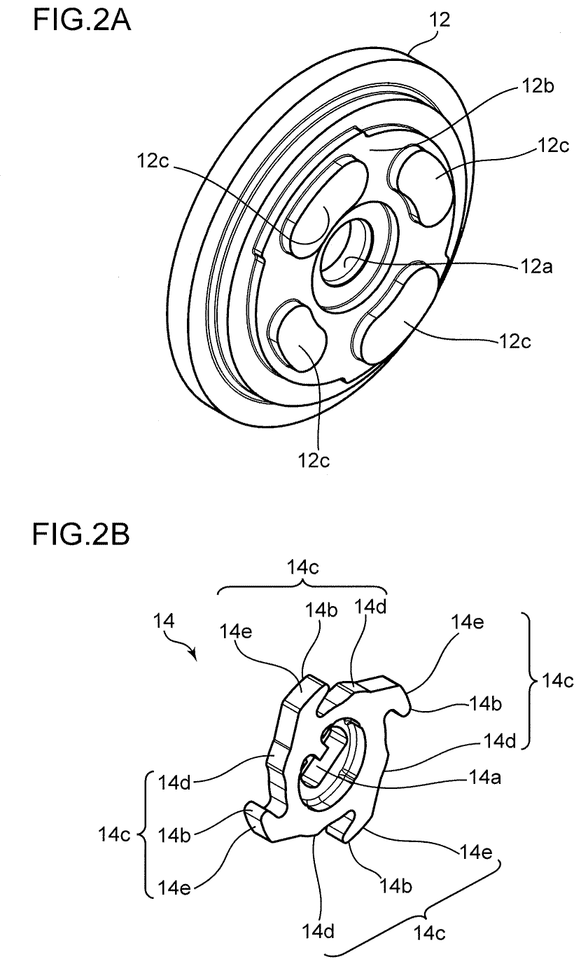

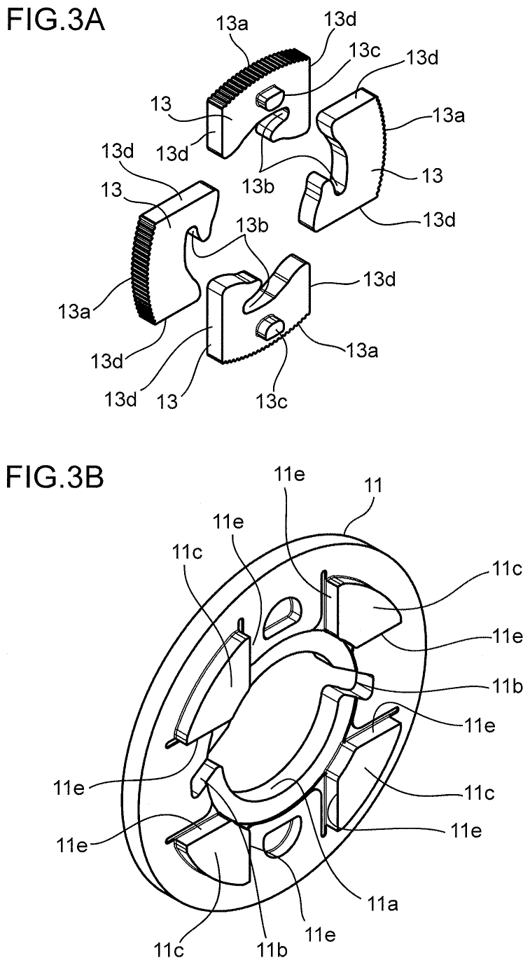

The configuration of the reclining device 1 for a seat according to the embodiment will be described with reference to FIG. 1, FIG. 2A, FIG. 2B, FIG. 3A, and FIG. 3B.

As illustrated in FIG. 1, the reclining device 1 for a seat (hereinafter, simply referred to as “reclining device 1”) includes a guide bracket 11, an internal gear 12, four lock gears 13, a rotation cam 14, a lock spring 15, a cam attachment plate 16, and a ring 17. The guide bracket 11 is an annular plate-shaped member configured to be fixedly attached to a seat cushion (not shown) and having a through hole 11a at the center thereof. As illustrated in FIG. 3B, the guide bracket 11 has four guide parts 11c on one surface thereof (that is closer to the lock gears 13). The four guide parts 11c are spaced at predetermined intervals in a circumferential direction in such a manner as to protrude toward the lock gears 13 respectively. Each guide part 11c has a side wall serving as a guide wall to guide the associated lock gear 13 to move in a radial direction of the internal gear 12. Thus, the side wall of the guide part 11c is defined as a guide wall 11e hereinafter.

As illustrated in FIG. 1 and FIG. 3B, the guide bracket 11 has two notches 11b each being continuous to the through hole 11a. Each notch 11b is to be engaged with an outer end 15a of the lock spring 15. As illustrated in FIG. 1, the guide bracket 11 has two protrusions 11d protruding from another surface (opposite to the one surface where the lock gears 13 are arranged) in a direction opposite to the lock gears 13. Each protrusion 11d serves to determine a position of the guide bracket 11 for fixing attachment to the seat cushion.

As illustrated in FIG. 1 and FIG. 2A, the internal gear 12 is a cylindrical member having a closed bottom, that is, a structure including a cylindrical part having an opening closed with a bottom wall 12b. The bottom wall 12b is integrally formed with the cylindrical part. The bottom wall 12b of the internal gear 12 has a through hole 12a in a central portion thereof. As illustrated in FIG. 2A, the bottom wall 12b of the internal gear 12 has four protrusions 12c. The four protrusions 12c protrude from an outer surface of the internal gear that is opposite to a surface where the guide bracket 11 is arranged in a direction opposite to the guide bracket 11. Each of the four protrusions 12c is used to fixedly attach the internal gear 12 to the seatback.

As illustrated in FIG. 1, the internal gear 12 has a ring part 12d in an annular shape protruding from a portion around the through hole 12a toward the guide bracket 11. The ring part 12d fits in a through hole 16a of the cam attachment plate 16. The internal gear 12 further has internal teeth 12e provided over an inner circumferential surface of the cylindrical part thereof. Each internal tooth 12e of the internal gear 12 is configured to mesh with an associated external tooth 13a of the lock gears 13.

As illustrated in FIG. 1 and FIG. 3A, each of the four lock gears 13 has the external teeth 13a provided on an outer circumferential surface thereof. As described above, each external tooth 13a is configured to mesh with the associated internal tooth 12e of the internal gear 12. Each lock gear 13 has a recess 13b on an inner circumferential surface that recesses to a certain position in a circumferential direction. The recess 13b allows a claw 14b of the rotation cam 14 to enter therein.

As illustrated in FIG. 3A, the lock gear 13 has side walls 13d each having a flat surface so as to be slidable along the associated guide wall 11e of the guide bracket 11. Two lock gears 13 facing each other among the four lock gears 13 respectively have protrusions 13c protruding toward the internal gear 12. Each protrusion 13c restricts movement in the circumferential direction relative to the internal gear 12 so as to fall within a predetermined range.

As illustrated in FIG. 1 and FIG. 2B, the rotation cam 14 has a through hole 14a in a central portion thereof. The through hole 14a has an oval shape, and receives a rod (not shown) of a manipulation lever to be fixed therein. The rotation cam 14 has four claws 14b on an outer circumference thereof. Each of the claws 14b can enter the associated recess 13b of the lock gear 13 as described above.

As illustrated in FIG. 2B, the rotation cam 14 has an outer circumferential surface having a cam face 14c to push the associated lock gear 13 toward a radially outside of the internal gear 12 by rotation of the rotation cam 14. The cam face 14c has bulges (cam bulges) 14d, 14e respectively bulging radially outward in the rotation.

As illustrated in FIG. 1, the rotation cam 14 has an engagement groove 14f extending in the radial direction in a portion around the through hole 14a that is closer to the guide bracket 11. The engagement groove 14f is to be engaged with an inner end 15b of the lock spring 15.

As described above, in the lock spring 15, the outer end 15a engages with the notch 11b of the guide bracket 11, and the inner end 15b engages with the engagement groove 14f of the rotation cam 14. In this manner, the lock spring 15 urges the rotation cam 14 in a locking direction (a clockwise direction in FIG. 1) relative to the guide bracket 11.

As illustrated in FIG. 1, the cam attachment plate 16 has the through hole 16a in a central portion thereof. As described above, the cam attachment plate 16 is rotatably attached to the internal gear 12 with the through hole 16a fitted to the ring part 12d of the internal gear 12. The cam attachment plate 16 has four dowels 16b spaced at predetermined intervals around the through hole 16a. The cam attachment plate 16 is attached to the rotation cam 14 through welding of the dowels 16b to the rotation cam 14.

The ring 17 is a substantially annular member to fixedly attach the guide bracket 11 and the internal gear 12 to each other with the lock gear 13, the rotation cam 14, and the cam attachment plate 16 disposed between the guide bracket 11 and the internal gear 12.

### 2. Locking State and Unlocking State Concerning the Reclining Device 1.

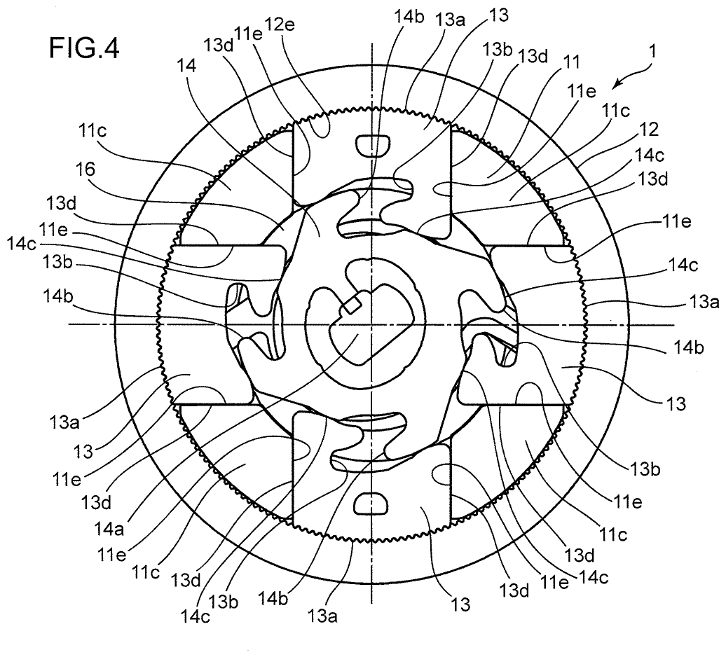

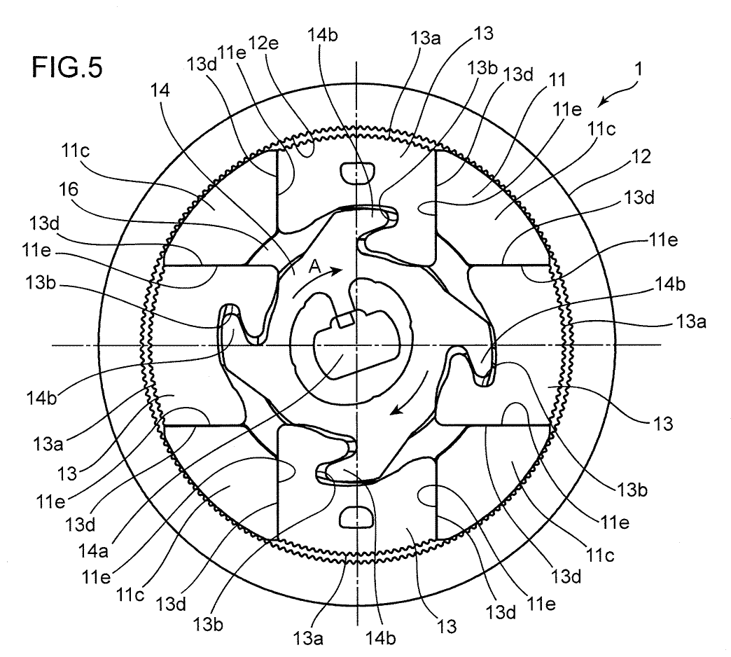

The locking state and the unlocking state concerning the reclining device 1 will be described with reference to FIG. 4 and FIG. 5. FIG. 4 illustrates the reclining device 1 in the locking state, and FIG. 5 illustrates the reclining device 1 in the unlocking state.

As illustrated in FIG. 4, when the reclining device 1 is in the locking state, each external tooth 13a of the lock gear 13 meshes with each internal tooth 12e of the internal gear 12. The lock gear 13 receives a radially outward load from the cam face 14c of the rotation cam 14 and is pushed radially outward.

As illustrated in FIG. 4, when the reclining device 1 is in the locking state, each claw 14b of the rotation cam 14 is away from the associated recess 13b of the lock gear 13 in the circumferential direction.

Next, as illustrated in FIG. 5, the reclining device 1 is placed in the unlocking state in response to rotation of the rotation cam 14 in an arrow-A direction in accordance with a manipulation to the manipulation lever by the user. In other words, the claw 14b of the rotation cam 14 enters the recess 13b of the lock gear 13 in response to the rotation of the rotation cam 14 in the arrow-A direction. In this manner, each lock gear 13 is pulled radially inward, so that the reclining device 1 transitions from the locking state to the unlocking state. Such radially inward movement of the lock gear 13 results from sliding of the side wall 13d of the lock gear 13 along the guide wall 11e of the guide bracket 11.

As described above, the radially inward movement of the lock gear 13 releases the meshing of the external tooth 13a of the lock gear 13 and the internal tooth 12e of the internal gear 12. This operation places the reclining device 1 in the unlocking state.

Conversely, for transition of the reclining device 1 from the unlocking state to the locking state, an operation for change from the state in FIG. 5 to the state in FIG. 4 may be performed. This operation makes each lock gear 13 pushed radially outward with an urging force of the lock spring 15 via the rotation cam 14, and the external tooth 13a meshes with the internal gear 11e. The cam face 14c of the rotation cam 14 comes into contact with a radially inward surface of the lock gear 13 to maintain the locking state.

### 3. Detailed Structure of the Lock Gear 13

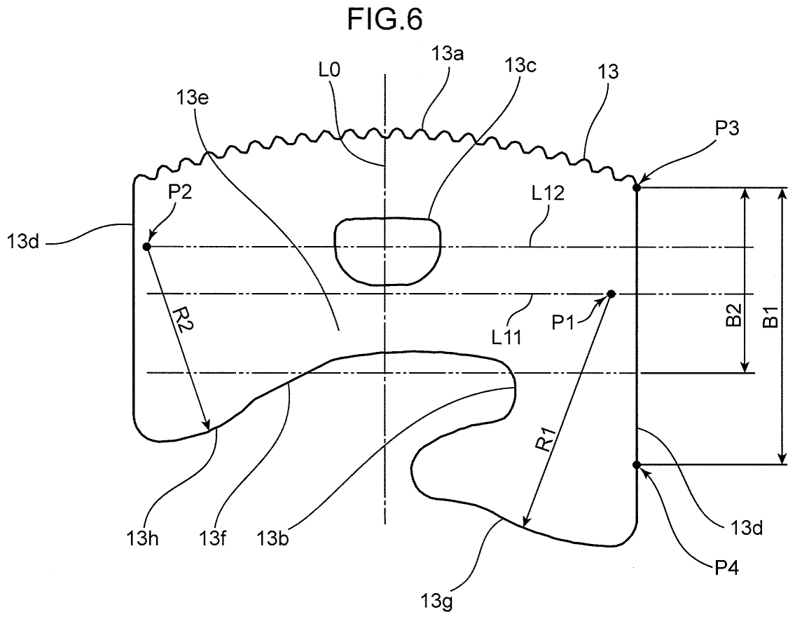

A detailed structure of the lock gear 13 will be described with reference to FIG. 6. In the description below, one side of the lock gear where the external teeth 13a are provided is defined as “radially outside” or “radially outward” and an opposite side thereto is defined as “radially inside” or “radially inward”. Besides, the word “radially” in this case means the “radial direction” of the internal gear 12.

As illustrated in FIG. 6, the lock gear 13 has the external teeth 13a on an outer circumferential surface on the radially outside. In the description, a portion of the lock gear 13 located on the radially inside from the outer circumferential surface where the external teeth 13a is provided is defined as a radially inner portion 13e.

The lock gear 13 has an inner circumferential surface 13f on the radially inside. The inner circumferential surface 13f has at least a surface section to come into contact with the cam face 14c of the rotation cam 14. The inner circumferential surface 13f has the recess 13b that allows the claw 14b of the rotation cam 14 to enter therein as described above. The inner circumferential surface 13f further has two gear bulges 13g, 13h bulging at two positions toward the cam face 14c farther than a periphery therearound.

In the embodiment, for example, the gear bulge 13g forms an arc with a radius R1 about an arc center P1, and the gear bulge 13h forms an arc with a radius R2 about an arc center P2.

On the side wall 13d of the lock gear 13, a radially outer end (sliding outer end) is defined as “P3” and a radially inner end (sliding inner end) is defined as “P4” for the sliding along the guide wall 11e of the guide bracket 11. Further, a distance from the sliding outer end P3 to the sliding inner end P4 in a direction along the side wall 13d is defined as “B1”. Moreover, a line passing the arc center P1 and perpendicularly intersecting a center line L0 is defined as an imaginary line L1, and a line passing the arc center P2 and perpendicularly intersecting the center line L0 is defined as an imaginary line L12.

In this case, each of the imaginary line L11 and the imaginary line L12 falls within a range of a distance B2 from the sliding outer end P3 to a certain position in a direction of the sliding inner end P4. The distance B2 is two-thirds of the distance B1. Specifically, in the embodiment, each of the arc center P1 of the gear bulge 13g and the arc center P2 of the gear bulge 13h falls within a range of the distance B2 (two-thirds of the distance B1) from the sliding outer end P3 on the radially inside in a direction along the side wall 13d. The exact position of each of the arc centers P1, P2 will be described in detail later.

Although the embodiment adopts a configuration including the two gear bulges 13g, 13h at two positions on the contact surface 13f of the lock gear 13, one, or three or more gear bulges may be formed at one, or three or more positions. Further, although each of the gear bulges 13g, 13h forms an arc entirely, each gear bulge may not necessarily form an arc entirely as long as the gear bulge includes a region to come into contact with the cam face 14c of the rotation cam 14.

### 4. Detailed Structure of the Cam Face 14c of the Rotation Cam 14

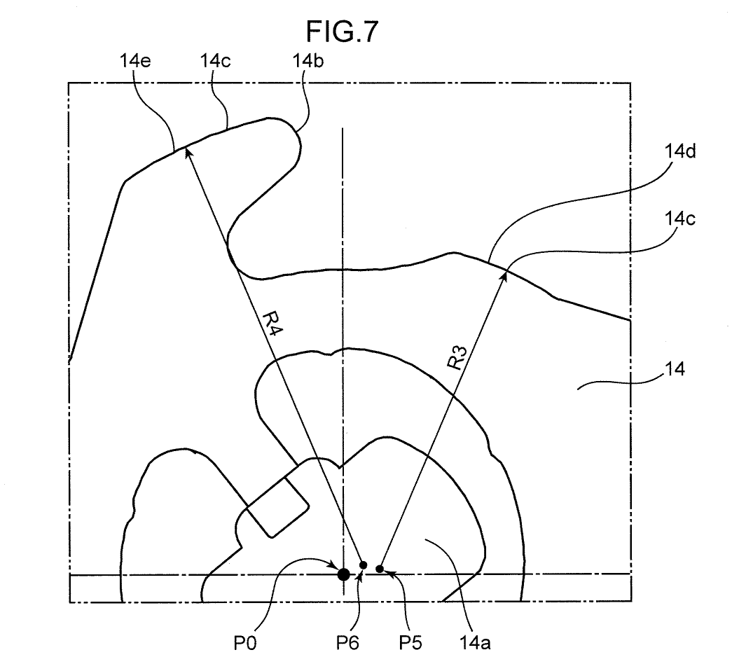

A detailed structure of the cam face 14c of the rotation cam 14 will be described with reference to FIG. 7. It is noted here that the terms “radially outside” or “radially outward” and “radially inside” or “radially inward” will be used in the following description with a similar definition to the definition used for the lock gear 13.

As illustrated in FIG. 7, the cam face 14c of the rotation cam 14 has the cam bulges 14d, 14e. Each of the cam bulges 14d, 14e bulges toward the surface section (to come into contact with the cam face 14c in the locking state) of the inner circumferential surface 13f of the lock gear 13 farther than a periphery therearound. In the embodiment, for example, the cam bulge 14d forms an arc with a radius R3 about an arc center P5, and the cam bulge 14e forms an arc with a radius R4 about an arc center P6.

Each of the arc centers P5, P6 is at a predetermined distance from a rotation center P0 of the rotation cam 14.

In the embodiment, the cam bulge 14d is located away from the claw 14b, and the cam bulge 14e is located in the vicinity of the claw 14b. Each of the cam bulges 14d, 14e may be located in any region to come into contact with the surface section of the inner circumferential surface 13f of the lock gear 13 without limitation to the aforementioned positions.

Although the embodiment adopts a configuration including the two cam bulges 14d, 14e at two positions on the cam face 14c of the rotation cam 14, one, or three or more cam bulges may be provided at one, or three or more positions. Although each of the cam bulges 14d, 14e forms an arc entirely in the embodiment, each cam bulge may not necessarily form an arc entirely as long as the cam bulge includes a region to come into contact with the surface section of the inner circumferential surface 13f of the lock gear 13.

### 5. Arc Center P1 of the Gear Bulge 13g and the Arc Center P2 of the Gear Bulge 13h in the Lock Gear 13

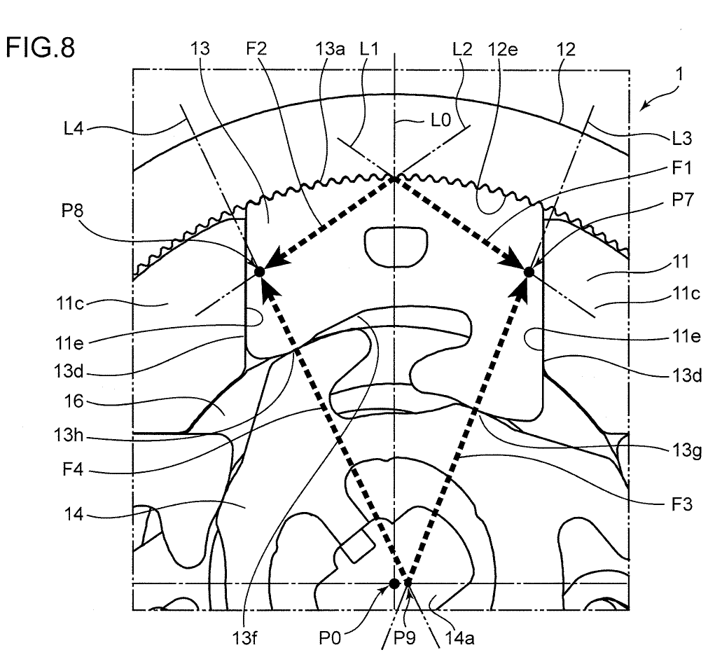

As described with reference to FIG. 6, each of the arc centers P1, P2 of the gear bulges 13g, 13h of the lock gear 13 falls within the range of the distance B2 (two-thirds of the distance B1) from the sliding outer end P3 on the radially inside in the direction along the side wall 13d, the sliding outer end P3 serving as a reference for the sliding along the guide wall 11e. In the embodiment, the arc center P1, P2 is located: at an intersection of a line (imaginary line) extending in a direction in which a resultant force including a radially inward force from the internal gear 12 in a locking state acts and a line (imaginary line) extending in a direction in which a load F3, F4 to enter the lock gear 13 from the rotation cam 14 through the gear bulge 13g, 13h acts. This configuration will be described with reference to FIG. 8.

As illustrated in FIG. 8, as for the locking state of the reclining device 1, first imaginary lines L1, L2 are drawn in directions in which resultant forces F1, F2 each including a radially inward force from the internal gear 12 respectively act. Besides, as for the locking state of the reclining device 1, second imaginary lines L3, L4 are drawn in directions in which loads F3, F4 to enter the lock gear 13 from the rotation cam 14 through the gear bulges 13g, 13h respectively act.

Here, the first imaginary line L1 drawn in the direction in which the resultant force F1 including the radially inner force from the internal gear 12 acts extends along a resultant vector of forces applied rearward of the seat (rightward in the sheet of FIG. 8), that is, applied onto rear faces of all the external teeth 13a of the lock gear 13 in the locking state. Similarly, the second imaginary line L2 drawn in the direction in which the resultant force F2 including the radially inner force from the internal gear 12 acts extends along a resultant vector of forces applied forward of the seat (leftward in the sheet of FIG. 8), that is, applied onto front faces of all the external teeth 13a of the lock gear 13 in the locking state.

As illustrated in FIG. 8, the second imaginary lines L3, L4 extend from the rotation cam 14 toward the lock gear 13 through the gear bulges 13g, 13h respectively, that is, extend from a point P9 serving as a start point and being in the vicinity of the rotation center P0 of the rotation cam 14 at a predetermined distance from the rotation center P0. The start points of the second imaginary lines L3, L4 may be the points P5, P6 shown in FIG. 7 respectively.

### 6. Force Acting to the Lock Gear 13 in the Locking State

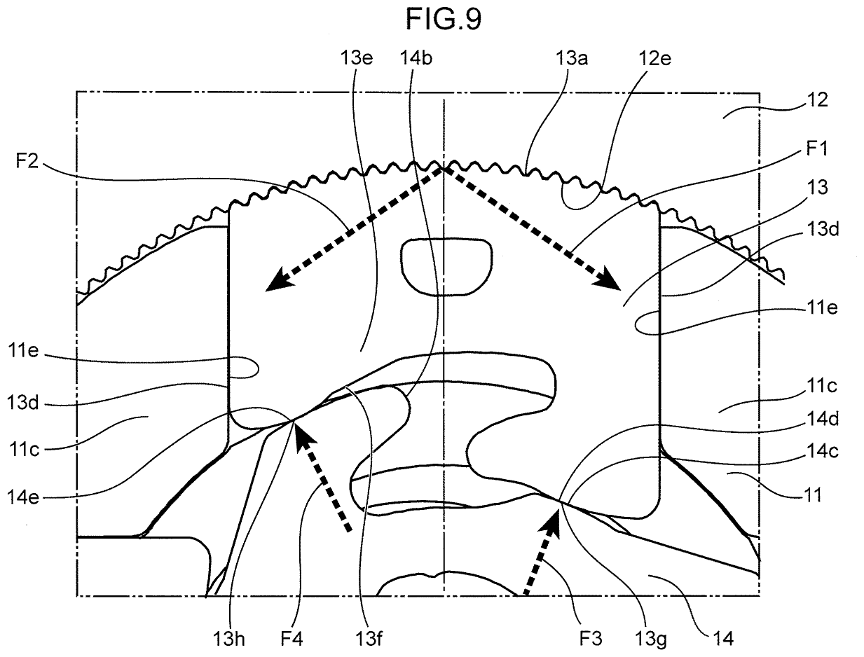

A force acting from each of the internal gear 12, the rotation cam 14, and the guide bracket 11 to the lock gear 13 in the reclining device 1 according to the embodiment will be described with reference to FIG. 9.

As illustrated in FIG. 9, in a state where no application of a rotation moment to the internal gear 12 in the front-rear direction (corresponding to the left-right direction in FIG. 9), a combination of the resultant forces F1, F2 each including the radial inward force from the internal gear 12 and a combination of the loads F3, F4 input from the rotation cam 14 into the lock gear 13 are balanced with each other.

Meanwhile, when a forward or rearward rotation moment is applied to the internal gear 12 in the front-rear direction of the seat, the resultant force F1 and the resultant force F2 become unbalanced, that is, one of the resultant forces increases and the other resultant force decreases. In this situation, one of forces applied from the side wall 13d of the lock gear 13 to the guide wall 11e of guide bracket 11 increases and the other force decreases in the left-right direction in FIG. 9. One of reaction forces from the guide wall 11e of the guide bracket 11 to the side wall 13d of the lock gear 13 increases and the other force decreases in association with the increase or decrease in the forces from the side wall 13d of the lock gear 13 to the guide wall 11e of the guide bracket 11.

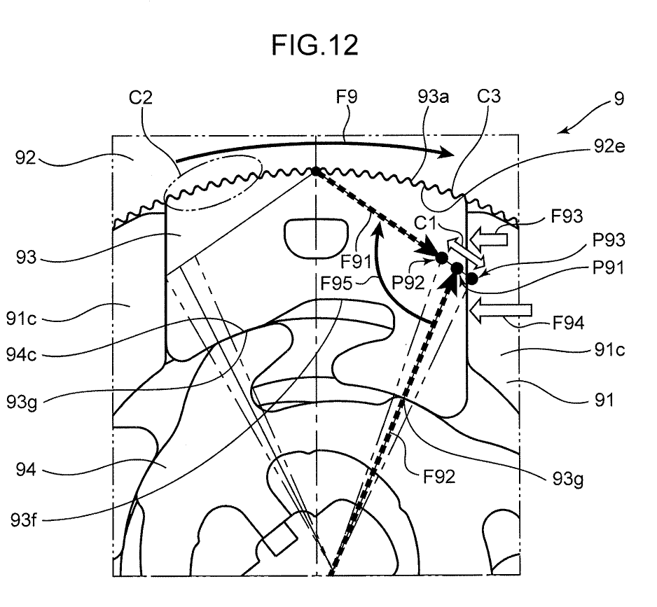

In this regard, in the reclining device 1 according to the embodiment, a surface section (to come into contact with the cam face 14c in the locking state) of the inner circumferential surface 13f of the lock gear 13 is provided with the gear bulges 13g, 13h having the features described above. In this configuration, the loads F3, F4 enter the lock gear 13 from the rotation cam 14 respectively through the gear bulges 13g, 13h each having an arc shape. The reclining device 1 according to the embodiment having this configuration can prevent the intersections P7, P8 described above with reference to FIG. 8 from deviating in the circumferential direction as shown in FIG. 12 even when a rotation moment in the front-rear direction is applied to the internal gear 12 in the locking state.

### 7. Advantageous Effects

In the reclining device 1 according to the embodiment, each of the lock gears 13 has the gear bulge 13g, 13h. The gear bulge 13g, 13h forms an arc, and has the arc center P1, P2 located at: the intersection P7, P8 of the first imaginary line L1, L2 and the second imaginary line L3, L4; or a position therearound, that is, a position between the intersection P7, P8 and the gear bulge 13g, 13h on the second imaginary line L3, L4. The arc center P1, P2 is preferably located at the intersection of the first imaginary line L1, L2 and the second imaginary line L3, L4, but may be preferably located at a position close to the intersection of the first imaginary line L1, L2 and the second imaginary line L3, L4 without limitation to the intersection. Hence, in the reclining device 1, even in a case where the lock gear 13 has variation in dimensional accuracy and an engagement portion of the cam face 14c of the rotation cam 14 with the gear bulge 13g, 13f of the inner circumferential surface 13f of the lock gear 13 in the locking state deviates from a designed and intended position in the circumferential direction, the load F3, F4 from the rotation cam 14 to the lock gear 13 is applied toward the arc center P1, P2 of the gear bulge 13g, 13h. Specifically, in the lock gear 13, the gear bulge 13g, 13h of the inner circumferential surface 13f comes into contact with the cam bulge 14d, 14e of the cam face 14c of the rotation cam 14, and the load F3, F4 having entered the gear bulge 13g, 13h of the lock gear 13 from the cam bulge 14d, 14e of the cam face 14c of the rotation cam 14 advances toward the arc center P1, P2. At this time, even if the lock gear 13 rotates in response to a moment input into the reclining device 1 in a case where the lock gear 13 has variation in the dimensional accuracy, the bulge 13g, 13h never remarkably deviates in the circumferential direction and the radial direction as long as the position of the intersection P7, P8 of the first imaginary line L1, L2 and the second imaginary line L3, L4 agrees with the arc center. This configuration thus enables suppression of a further rotational force of the lock gear 13 as illustrated in FIG. 12.

Accordingly, the reclining device 1 achieves prevention of a reduction in the locking strength even against a high load from the seatback with tolerance to variation in the dimensional accuracy of the lock gear 13.

In the reclining device 1, the arc center P1, P2 of the gear bulge 13g, 13h falls within a range of the distance B2 (two-thirds of the distance B1) from the sliding outer end P3. For example, the arc center P1, P2 of the gear bulge 13g, 13h is located in a radially inward region exceeding the distance B2 (two-thirds of the distance B1) from the sliding outer end P3. In this example, when the lock gear tilts in response to an input moment, the intersection may deviate radially outward and the lock gear 13 is likely to rotate, which is unpreferable.

In contrast, even if the lock gear slightly tilts toward the guide wall 11e from the intersection as the center in response to a rotation moment applied to the internal gear 12 in the front-rear direction, there is no remarkable change in the position of the arc center P1, P2 of the gear bulge 13g, 13h in the recliner under the condition that the arc center P1, P2 falls within the range of the distance B2 (two-thirds of the distance B1) from the arc center P1, P2. Thus, the reclining device 1 has no significant difference in reaction forces from the guide bracket 11 to the lock gear 13 between a radially inner position and a radially outer position of the arc center P1, P2. The configuration prevents the lock gear 13 from excessively moving away from the internal teeth of the internal gear, and thus enables suppression of a further rotational force of the lock gear 13 as illustrated in FIG. 12. This results in avoiding a damage to the external teeth 13a of the lock gear 13.

The configuration in which the gear bulge 13g, 13h of the lock gear 13 has the arc center P1, P2 falling within the range of the distance B2 from the sliding outer end P3 achieves prevention of a reduction in the locking strength of the reclining device 1 even in the case where the lock gear 13 has variation in the dimensional accuracy and an engagement portion of the cam face 14c of the rotation cam 14 with the gear bulge 13g, 13h of the inner circumferential surface 13f of the lock gear 13 in the locking state deviates from the designed and intended position in the circumferential direction. The arc center P1, P2 is preferably on the second imaginary line L3, L4 and preferably falls within the range of two-thirds of the distance B1, and is further preferably located closer to the intersection P7, P8 of the first imaginary line L1, L2 and the second imaginary line L3, L4.

In the reclining device 1, the rotation cam 14 has the cam bulge 14d, 14e having the arc center P5, P6 being at a predetermined distance from the rotation center P0 of the rotation cam 14. The reclining device 1 having this configuration achieves prevention of a reduction in the locking strength even against a high load applied between the internal teeth 12e of the internal gear 12 and the external teeth 13a of the lock gear 13 in the locking state. This is because the location of the arc center P5, P6 of the cam bulge 14d, 14e of the rotation cam 14 at the predetermined distance from rotation center P0 leads to achievement in stabilization of a force input from the rotation cam 14 to the lock gear 13 in a certain direction.

As described heretofore, the reclining device 1 according to the embodiment achieves prevention of a reduction in the locking strength of the reclining device even against a high load from the seatback with tolerance to variation in the dimensional accuracy of the lock gear 13.

### Modifications

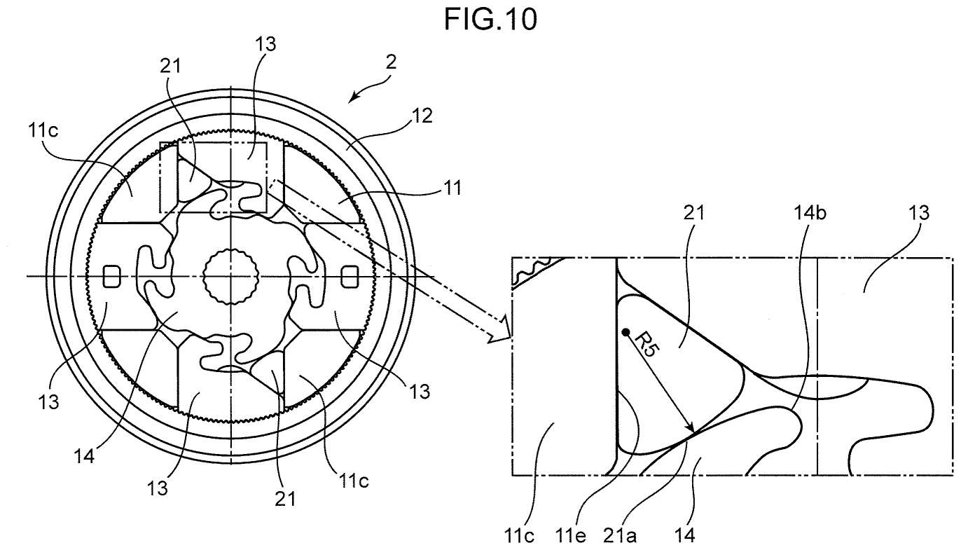

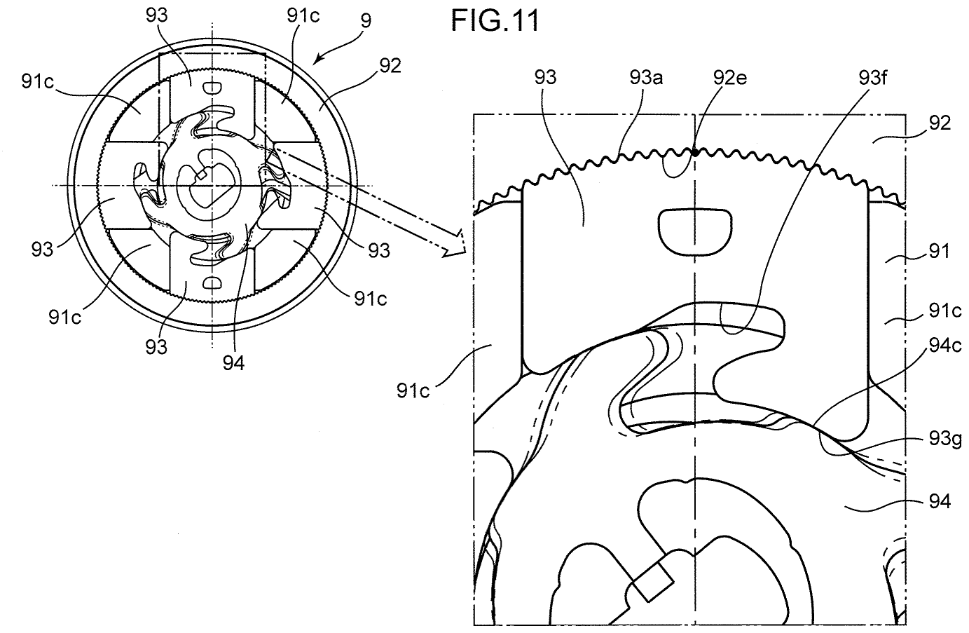

A configuration of a reclining device 2 for a seat (hereinafter, simply referred to as “reclining device 2”) according to a modification will be described with reference to FIG. 10. In FIG. 10, constituent elements which are the same as the constituent elements of the reclining device 1 according to the embodiment are given the same reference signs or numerals. Duplicative description about the embodiment will be omitted.

As illustrated in FIG. 10, the reclining device 2 according to the modification additionally includes two wedges 21 in comparison with the reclining device 1 according to the embodiment. Each of the wedges 21 has a substantially triangular shape with a side forming arc in a plan view. Each wedge 21 is arranged with a face thereof in an arc shape being in contact with a cam face 14c of a rotation cam 14. Specifically, the wedge 21 has a contact face 21a having an arc shape and being in contact with the cam face 14c of the rotation cam 14.

In the embodiment, each wedge 21 is interposed between an associated guide part 11c of a guide bracket 11 and corresponding one of two lock gears 13 facing each other among four lock gears 13. Such a wedge 21 may be interposed between an associated guide part 11c of the guide bracket 11 and each of all the four lock gears 13.

As shown in the partially enlarged view in FIG. 10, the contact face 21a of the wedge 21 forms an arc to protrude inward in a radial direction of an internal gear 12 in the same manner as the gear bulge 13g, 13h in the embodiment.

The reclining device 2 according to the modification can provide the same advantageous effects as the effects of the reclining device 1 according to the embodiment. In addition, the reclining device 2 according to the modification includes the wedge 21 interposed between each of the two lock gears 13 and the associated guide wall 11e of the guide part 11c, and thus achieves prevention of rattling of each lock gear 13 while maintaining high locking strength. In other words, the wedge 21 has the contact face 21a forming an arc and being in contact with the cam face 14c, and serves to constitute a part of the lock gear 13, and thus achieves prevention of rattling of the lock gear 13 relative to the internal gear 12 while maintaining high locking strength at locking.

### Other Modifications

Although each of the embodiment and the modification adopts a configuration including the four lock gears 13, the present invention does not limit the number of lock gears 13. For instance, two, three, or five or more lock gears may be provided.

Although the guide bracket 11 is configured to be fixedly attached to the seat cushion and the internal gear 12 is configured to be fixedly attached to the seatback in each of the embodiment and the modification, conversely, the guide bracket 11 may be fixedly attached to the seatback and the internal gear 12 may be fixedly attached to the seat cushion in the present invention.

Although the inner circumferential surface 13f of the lock gear 13 is provided with the gear bulge 13g, 13f and the cam face 14c of the rotation cam 14 is provided with the cam bulge 14d, 14e in each of the embodiment and the modification, the cam bulge 14d, 14e is not indispensable in the present invention.

Although each of the embodiment and the modification adopts a configuration in which the inner circumferential surface 13f of the lock gear 13 is provided with the two gear bulges 13g, 13h at two positions respectively in each of the embodiment and the modification, the present invention may sufficiently include at least one gear bulge at one position. Similarly, although the cam face 14c of the rotation cam 14 is provided with the two cam bulges 14d, 14e at two positions respectively in each of the embodiment and the modification, the present invention may sufficiently include at least one cam bulge at one position.

Although an outer edge of the gear bulge 13g, 13h of the lock gear 13 bulging toward the cam face 14c forms an arc entirely in each of the embodiment and modification, at least only a region of the gear bulge to come into contact with the cam face may form an arc in the present invention. Similarly, although an outer edge of the cam bulge 14d, 14e of the rotation cam 14 bulging toward a face section (to come into contact with the cam face) of the inner circumferential surface 13f forms an arc entirely in each of the embodiment and the modification, at least only a region of the cam bulge to come into contact with the contact face may form an arc.

### Conclusion

A reclining device for a seat according to an aspect of the present invention includes a guide bracket, an internal gear, a plurality of lock gears, and a rotation cam. The guide bracket is configured to be fixedly attached to one of a seat cushion and a seatback. The internal gear is configured to be fixedly attached to the other of the seat cushion and the seatback in such a manner as to be rotatable relative to the guide bracket, the internal gear having internal teeth on an inner circumferential surface thereof. The lock gears are each located on a radially inside of the internal gear movably in a radial direction of the internal gear, and each have an external tooth configured to mesh with an associated internal tooth among the internal teeth.

The rotation cam is located on the radially inside relative to the lock gears rotatably about a radial center of the internal gear and having a cam face to come into contact with at least a surface section of an inner circumferential surface being a radially inward surface of each of the lock gears. The rotation cam is configured to switch between a locking state where the internal tooth and the external tooth mesh and an unlocking state where the meshing of the internal tooth and the external tooth is released depending on a pushing state from the cam surface to the surface section.

The guide bracket has a guide wall that guides corresponding one of the lock gears to move in the radial direction. At least one of the lock gears has at least one gear bulge in a region of the surface section of the inner circumferential surface that faces the cam face of the rotation cam, at least a portion of the gear bulge forming an arc to protrude toward the cam face.

The gear bulge is in such a form that the arc of the gear bulge has a center located at: an intersection of a first imaginary line and a second imaginary line; or a position between the intersection and the gear bulge on the second imaginary line. The first imaginary line extends in a direction in which a resultant force including a radially inward force from the internal gear in the locking state acts. The second imaginary line extends in a direction in which a load to enter the lock gear from the rotation cam through the gear bulge acts.

In the reclining device for a seat according to the aspect, at least one of the lock gears has a gear bulge. The gear bulge has at least a portion (including a portion to constitute a surface section to come into contact with the cam face of the rotation cam) forming an arc, and the arc has a center located at the intersection or a position therearound, that is, a position between the intersection and the gear bulge on the second imaginary line. Hence, in the reclining device for a seat according to the aspect, even in a case where the lock gear has variation in dimensional accuracy and an engagement portion of the cam face of the rotation cam with the gear bulge of the inner circumferential surface of the lock gear in the locking state deviates from a designed and intended position in the circumferential direction, the load from the rotation cam to the lock gear is applied toward the center of the arc of the gear bulge.

In other words, in the lock gear, the portion of the inner circumferential surface of the gear bulge that forms an arc comes into contact with the cam face of the rotation cam. A load input into the portion of the gear bulge of the lock gear that forms the arc advances toward the center of the arc. Hence, even in the case where the lock gear has variation in dimensional accuracy and an engagement portion of the cam face of the rotation cam with the gear bulge of the inner circumferential surface of the lock gear in the locking state deviates from the designed and intended position in the circumferential direction, the reclining device for a seat according to the aspect avoids a change in the position of the intersection and prevents the rotational force as shown in FIG. 12 from acting to the lock gear.

Accordingly, the reclining device for a seat according the aspect achieves prevention of a reduction in the locking strength even against a high load from the seatback with tolerance to variation in the dimensional accuracy of the lock gear.

In the reclining device for a seat according to the aspect, a sliding extent in each of the lock gears along the guide wall is defines as “B1”. In this case, the center of the arc of the gear bulge preferably falls within a range of two-thirds of the sliding extent B1 from a sliding outer end of the sliding extent being an end where the external tooth is located to a sliding inner end of the sliding extent opposite to the sliding outer end in a moving direction of the lock gear.

The reclining device for a seat according to the aspect has no significant difference in reaction forces from the guide bracket to the lock gear between a radially inner position and a radially outer position of the center of the arc under the condition that the center of the arc of the gear bulge falls within the range of two-thirds. This achieves prevention of a reduction in the locking strength of the reclining device with a simple structure.

In the reclining device for a seat according to the aspect, the cam face of the rotation cam preferably has, at a position to come into contact with the surface section of the lock gear, at least one cam bulge bulging toward the surface section farther than a periphery therearound. In this case, the cam bulge preferably has at least a portion to come into contact with the surface section of the lock gear and forming an arc, and the arc of the cam bulge has a center at a predetermined distance from a rotation center of the rotation cam.

In the reclining device for a seat according to the aspect, the rotation cam has the cam bulge forming the arc having the center at a predetermined distance from the rotation center of the rotation cam. This configuration achieves prevention of a reduction in the locking strength even against a high load applied between the internal teeth of the internal gear and the external teeth of the lock gear in the locking state. This is because the above-described location of the center of the arc of the cam bulge of the rotation cam leads to achievement in stabilization of a force input from the rotation cam to the lock gear in a certain direction.

The reclining device for a seat according to the aspect may further include a wedge located among at least one lock gear among the lock gears, the guide wall that guides the lock gear to move, and the rotation cam. The wedge preferably has at least a portion being in contact with the cam face and forming an arc to protrude toward the cam face.

The reclining device for a seat according to the aspect includes the wedge interposed between at least one of the lock gears and the guide wall, and thus achieves prevention of rattling of each lock gear while maintaining high locking strength.

Conclusively, the reclining device for a seat according the aspect achieves prevention of a reduction in the locking strength even against a high load from the seatback with tolerance to variation in the dimensional accuracy of the lock gear.

1. A reclining device for a seat, comprising:
a guide bracket configured to be fixedly attached to one of a seat cushion and a seatback;
an internal gear configured to be fixedly attached to the other of the seat cushion and the seatback in such a manner as to be rotatable relative to the guide bracket, the internal gear having internal teeth on an inner circumferential surface thereof;
a plurality of lock gears each located on a radially inside of the internal gear movably in a radial direction of the internal gear, and having an external tooth configured to mesh with an associated internal tooth among the internal teeth; and
a rotation cam located on the radially inside relative to the lock gears rotatably about a radial center of the internal gear and having a cam face to come into contact with at least a surface section of an inner circumferential surface being a radially inward surface of each of the lock gears, the rotation cam being configured to switch between a locking state where the internal tooth and the external tooth mesh and an unlocking state where the meshing of the internal tooth and the external tooth is released depending on a pushing state from the cam face to the surface section, wherein
the guide bracket has a guide wall that guides corresponding one of the lock gears to move in the radial direction,
at least one of the lock gears has at least one gear bulge in a region of the surface section of the inner circumferential surface that faces the cam face of the rotation cam, at least a portion of the gear bulge forming an arc to protrude toward the cam face, and
the gear bulge is in such a form that the arc of the gear bulge has a center located at: an intersection of a first imaginary line extending in a direction in which a resultant force including a radially inward force from the internal gear in the locking state acts and a second imaginary line extending in a direction in which a load to enter the lock gear from the rotation cam through the gear bulge acts; or a position between the intersection and the gear bulge on the second imaginary line.

2. The reclining device for a seat according to claim 1, wherein a sliding extent in each of the lock gears along the guide wall is defined as “B1”, and the center of the arc of the gear bulge falls within a range of two-thirds of the sliding extent B1 from a sliding outer end of the sliding extent being an end where the external tooth is located to a sliding inner end of the sliding extent opposite to the sliding outer end in a moving direction of the lock gear.

3. The reclining device for a seat according to claim 2, wherein the cam face of the rotation cam has, at a position to come into contact with the surface section of the lock gear, at least one cam bulge bulging toward the surface section farther than a periphery therearound.

4. The reclining device according to claim 3, wherein the cam bulge has at least a portion to come into contact with the surface section of the lock gear and forming an arc, and the arc of the cam bulge has a center at a predetermined distance from a rotation center of the rotation cam.

5. The reclining device for a seat according to any one of claim 1, further comprising a wedge located among at least one lock gear among the lock gears, the guide wall that guides the lock gear to move, and the rotation cam, wherein
the wedge has at least a portion being in contact with the cam face and forming an arc to protrude toward the cam face.

6. The reclining device for a seat according to claim 1, wherein the cam face of the rotation cam has, at a position to come into contact with the surface section of the lock gear, at least one cam bulge bulging toward the surface section farther than a periphery therearound.

7. The reclining device according to claim 6, wherein the cam bulge has at least a portion to come into contact with the surface section of the lock gear and forming an arc, and the arc of the cam bulge has a center at a predetermined distance from a rotation center of the rotation cam.
